(19) United States
(12) Patent Application Publication
(10) Pub. No.: US 2017/0277703 A1
(43) Pub. Date: Sep. 28, 2017

(54) Method for Displaying Webpage and Server

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Zheng GUO, Beijing (CN)

(73) Assignees: LE HOLDINGS (BEIJING) CO., LTD., Beijing (CN); LE SHI INTERNET INFORMATION & TECHNOLOGY CORP., BEIIJING, Beijing (CN)

(21) Appl. No.: 15/242,294

(22) Filed: Aug. 19, 2016

Related U.S. Application Data
(63) Continuation of application No. PCT/CN2016/088487, filed on Jul. 4, 2016.

(30) Foreign Application Priority Data
Mar. 22, 2016 (CN) 201610165420.4

(51) Int. Cl. G06F 17/30; G06F 17/24; G06F 17/21

(52) U.S. Cl. CPC G06F 17/3089; G06F 17/212; G06F 17/248

(57) ABSTRACT

The present disclosure relates to a method and an apparatus for displaying a webpage, wherein a server receives a webpage access request sent by a client terminal, acquires identification information of the client terminal that sends the webpage access request, and determines a name of the client terminal via the identification information. The server acquires a page layout template of the client terminal, then lays out page contents requested by the webpage access request according to the acquired page layout template, generates a webpage to be accessed, and send said webpage to be accessed to the client terminal that sends the webpage access request.

### CROSS REFERENCE TO RELATED APPLICATION

This application is a continuation of International Application No. PCT/CN2016/088487, with an international filing date of Jul. 4, 2016, which claims priority to Chinese Patent Application CN201610165420.4, filed with State Intellectual Property Office on Mar. 22, 2016, which is incorporated herein by reference in its entirety.

### FIELD OF TECHNOLOGY

The present disclosure relates to the field of computer technologies, and in particular, to a method for displaying a webpage and a server.

### BACKGROUND

In World Wide Web (WWW) environment, webpage (web page) is a platform carrying various website applications. Webpage is a plain text file containing HyperText Markup Language (HTML), and webpage elements may include text, images, animation, voices, videos, programs, tables and navigation bars, etc. A webpage may be read via a browser or other applications (APPs) on an intelligent terminal.

Page layouts of different websites are different. For example, for some pages, texts and pictures are displayed separately; for some pages, text is overlaid on images; for some pages, blocks are set laterally in a single row; and for some pages, blocks are set laterally in multiple rows. Page styles may be inconsistent with each other. On the other hand, after a page layout design for one same website has been completed, the page style thereof will usually be fixed. Even if a user read the webpage on different platforms, a fixed style with a preset layout design will be presented to the user. For example, when a user opens a video webpage via a certain video application, the page style thereof will be the same as the page style displayed when the video webpage is opened via a certain browser. That is to say, the style of a webpage opened by a certain platform may be inconsistent with the page style of said platform. This will cause an inconsistent visual feelings of the user, and a feeling of discontinuity and abruptness will be generated, which may lead to a poor user experience.

### SUMMARY

The present disclosure provides a method for displaying a webpage and a server, thereby solves the above technical problem.

In one aspect, an embodiment of the disclosure provides a method for displaying a webpage, including:

receiving a webpage access request sent by a client terminal, and acquiring identification information of the client terminal;

acquiring a page layout template of the client terminal corresponded to the identification information;

laying out contents of the webpage requested by the webpage access request according to the page layout template, and obtaining a webpage to be accessed; and

sending the webpage to be accessed to the client terminal.

In the second aspect, an embodiment of the disclosure further provides a non-volatile computer storage medium for storing computer executable commands, wherein the computer executable commands are configured to execute any one of the above methods for displaying a webpage according to the present disclosure.

In the third aspect, an embodiment of the disclosure further provides a server that includes: at least one processor; and a memory communicably connected with the at least one processor for storing instructions executable by the at least one processor, wherein execution of the instructions by the at least one processor causes the at least one processor to execute any one of the above methods for displaying a webpage according to the present disclosure.

### BRIEF DESCRIPTION OF THE DRAWINGS

To illustrate more clearly the technical solutions of the embodiments of the present disclosure or the prior art, the drawings for the description of the embodiments or the prior art will be introduced briefly as follows. Apparently, the drawings in the description below are merely used for description of some embodiments of the present disclosure, and a person ordinary skilled in the art may further obtain other figures according to these figures without creative work.

FIG. 1 is a schematic flow chart of a method for displaying a webpage according to an embodiment of the disclosure;

FIG. 2 is a schematic flow chart of another method for displaying a webpage according to an embodiment of the disclosure;

FIG. 3 is a schematic flow chart of yet another method for displaying a webpage according to one embodiment of the disclosure;

FIG. 4 is a block diagram of an apparatus for displaying a webpage according to an embodiment of the disclosure;

FIG. 5 is a block diagram of another apparatus for displaying a webpage according to one embodiment of the disclosure; and

FIG. 6 is a block diagram of a server according to one embodiment of the disclosure.

### DETAILED DESCRIPTION

The technical solutions of the embodiments of the disclosure will be described clearly and fully below in conjunction with the drawings in the embodiments of the disclosure, such that a person in the art may have a better understanding of the present disclosure. Apparently, the embodiments described herein are only part of the embodiments of the present invention, but not all of them. Any other embodiments obtained by one of ordinary skills in the art based on the embodiments of the disclosure without creative work should fall within the protection scope of the invention.

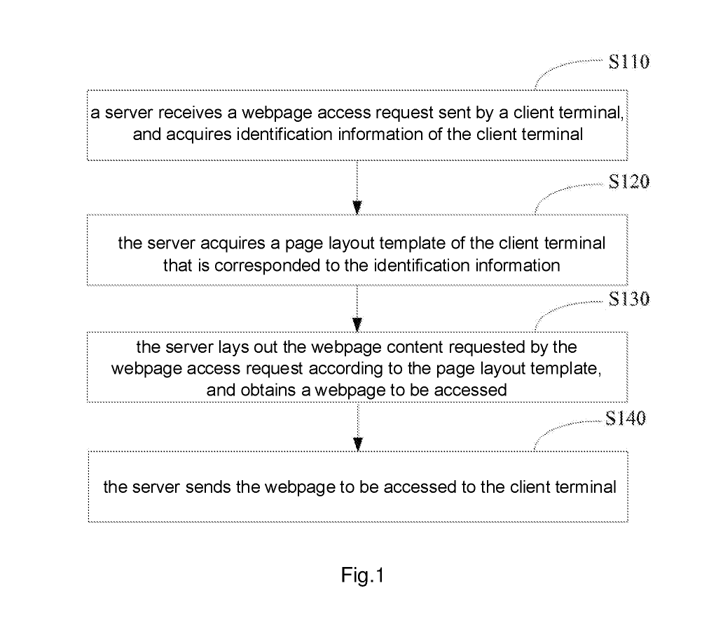

Referring to FIG. 1, a schematic flow chart of a method for displaying a webpage according to an embodiment of the disclosure is provided. As shown in FIG. 1, the method includes:

In Step S110: a server receives a webpage access request sent by a client terminal, and acquires identification information of the client terminal.

The client terminal may be various application platforms running on a terminal device, for example, an application (for example, a browser or other application platforms) that is installed on an intelligent mobile device such as an intelligent mobile phone or a tablet computer and may open a webpage.

The server may determine the name of the client terminal, for example, Sohu video application, UC browser, etc., according to the identification information.

According to some embodiments of the disclosure, a code program for acquiring identification information of a client terminal is embedded into the running webpage, such that the code program may run to acquire identification information of the client terminal that runs the webpage before the client terminal opens the webpage; thereafter, the acquired identification information of the client terminal will be sent to the server.

According to other embodiments of the disclosure, the server may passively receive identification information sent by the client terminal; for example, the identification information may be carried in a webpage access request sent by the client terminal; after the server receives the webpage access request sent by the client terminal, it may extract the identification information of the client terminal from the webpage access request.

In Step S120: the server acquires a page layout template of the client terminal that is corresponded to the identification information.

The server acquires page layout structures of various client terminals in advance, and generates corresponding page layout templates. After the client terminal that sends the webpage access request has been determined according to the identification information, a page layout template corresponded to the client terminal may be acquired from the page layout templates generated in advance.

In Step S130: the server lays out the webpage content requested by the webpage access request according to the page layout template, and obtains a webpage to be accessed.

The server lay out the content of the webpage requested to be accessed by the client terminal according to the page layout template of the client terminal, and generates the webpage to be accessed.

For example, if page blocks of a client terminal are set laterally in a single row, a page layout template with a single lateral row will be generated; if page blocks of the webpage requested to be accessed by the client terminal are set laterally in multiple rows, the blocks of the webpage requested to be accessed by the client terminal will be adjusted as one single lateral row according to the single lateral row layout of the client terminal.

In Step S140: the server sends the webpage to be accessed to the client terminal.

The server sends the webpage to be accessed, which is generated according to the webpage layout template, to the client terminal, such that it may displayed by the client terminal.

In the method for displaying a webpage according to this embodiment, the page layout pattern of the webpage to be accessed may be adjusted according to the page layout pattern of the client terminal that opens said webpage, that is, no matter what kind of client terminal is used to open the webpage, the page layout pattern of the webpage may be adjusted according to the page layout pattern of the client terminal, so that page layout pattern of a page of other websites displayed by the client terminal may be consistent with the page layout pattern of the client terminal itself. Thus, the user may have a consistent visual feeling and an improved user experience.

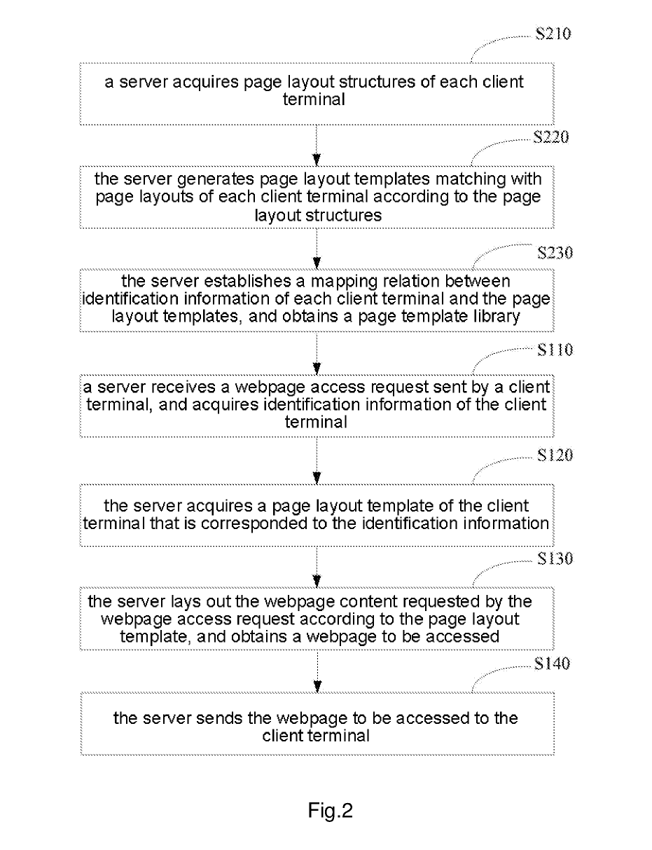

Referring to FIG. 2, a schematic flow chart of another method for displaying a webpage according to an embodiment of the disclosure is provided. On the basis of the method shown in FIG. 1, this method includes further steps of:

In Step S210: a server acquires page layout structures of each client terminal; wherein the page layout structures include page element collocation fashion and color information.

In some embodiments of the disclosure, page layout structure for each dominant client terminal may be analyzed by a webpage developer, that is, page layout pattern (for example, collocation fashion and color information, etc., of webpage elements) for each client terminal may be acquired by a webpage developer.

In other embodiments of the disclosure, the server may extract a page of the client terminal, and further analyze the layout structure of the page.

In Step S220: the server generates page layout templates matching with page layouts of each client terminal according to the page layout structures.

The server generates page layout templates consistent with the page patterns for the client terminal according to the page layout structures of the client terminals.

In Step S230: the server establishes a mapping relation between identification information of each client terminal and the page layout templates, and obtains a page template library.

After the page template library is generated, when the server obtains identification information of a client terminal, the server may search for the page layout template that matches with the identification information in the page template library according to the identification information.

It should be noted that, the process of generating page layout templates in advance needs to be performed only once, and page layout templates thus generated may be directly used afterwards.

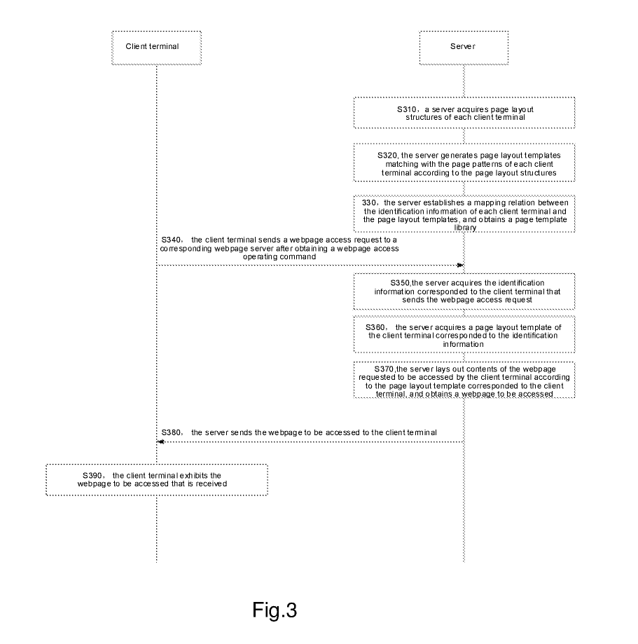

Referring to FIG. 3, a schematic flow chart of a yet further method for displaying a webpage according to an embodiment of the disclosure is provided. For easy understanding, this embodiment will be illustrated in conjunction with a client terminal and a server. As shown in FIG. 3, the method for displaying a webpage may include the steps of:

In Step S310: a server acquires page layout structures of each client terminal.

In Step S320: the server generates page layout templates matching with the page patterns of each client terminal according to the page layout structures.

In Step S330: the server establishes a mapping relation between the identification information of each client terminal and the page layout templates, and obtains a page template library.

In Step S340: a client terminal sends a webpage access request to a corresponding webpage server after obtaining a webpage access operating command.

For example, after a video application client terminal recognizes an operation that a user clicks a certain video, the video application client terminal will send a webpage access request to the server corresponded to the video resource.

In Step S350: the server acquires the identification information corresponded to the client terminal that sends the webpage access request.

In Step S360: the server acquires a page layout template of the client terminal corresponded to the identification information;

In Step S370: the server lays out contents of the webpage requested to be accessed by the client terminal according to the page layout template corresponded to the client terminal, and obtains a webpage to be accessed.

For example, if page blocks of the client terminal are set laterally in a single row, a page layout template with a single lateral row will be generated; if page blocks of the webpage requested to be accessed by the client terminal are set laterally in multiple rows, the blocks of the webpage requested to be accessed by the client terminal will be adjusted as one single lateral row according to the single lateral row layout of the client terminal.

In Step S380: the server sends the webpage to be accessed to the client terminal.

In Step S390: the client terminal exhibits the webpage to be accessed that is received by said terminal.

In the method for displaying a webpage according to this embodiment, after receiving the webpage access request sent by the client terminal, the server will acquire the identification information of the client terminal that sends the webpage access request, determine the name of the client terminal via the identification information, obtain a page layout template of the client terminal, then lay out the contents of the page requested by the webpage access request according to the page layout template obtained, generate a webpage to be accessed, and send said webpage to be accessed to the client terminal that sends the webpage access request. Therefore, page layout pattern of the webpage to be accessed may be adjusted according to the page pattern of the client terminal that opens said webpage, that is, no matter what kind of client terminal is used to open the webpage, the page layout pattern of the webpage may be adjusted according to the page layout pattern of the client terminal, so that pages of other websites displayed by the client terminal may be consistent with the page layout pattern of the client terminal itself. Thus, the user may have a consistent visual feeling and an improved user experience. Moreover, once page layout templates have been generated, they may be used directly afterwards, so as to improve webpage generation speed.

According to the description in connection with the above embodiments, it may be clearly understood by those ordinarily skilled in the art that the present disclosure may be realized by means of software in combination with necessary universal hardware platform, and certainly, may further be realized by means of hardware; but in many cases, the former is preferred. Based on such understanding, the above technical solutions in substance or the part thereof that makes a contribution to the prior art may be embodied in a form of a software product which may be stored in a computer-readable storage medium that may be used to store program code, for example, Read-Only Memory (ROM), Random-Access Memory (RAM), magnetic disc or compact disc, etc., and includes several commands for allowing a computer apparatus (which may be a personal computer, a server, a network apparatus or the like) to execute the methods described in various embodiments or some parts thereof.

Corresponding to the embodiments of the method for displaying a webpage according to the invention, the invention further provides embodiments of a device for displaying a webpage.

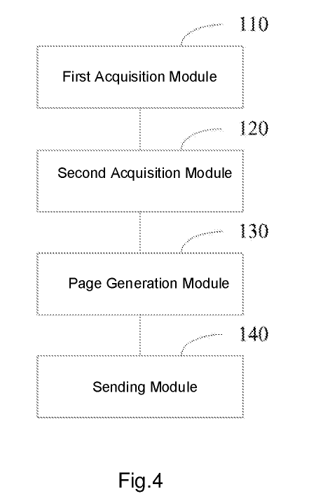

Referring to FIG. 4, it shows a structural representation of an apparatus for displaying a webpage according to one embodiment of the invention, which is applied to a server. As illustrated in FIG. 4, the apparatus for displaying a webpage includes: a first acquisition module 110, a second acquisition module 120, a page generation module 130 and a sending module 140.

The first acquisition module 110 is configured for receiving a webpage access request sent by a client terminal, and acquiring identification information of the client terminal.

The client terminal may be various application platforms running on a terminal device, for example, an application that is installed on an intelligent mobile device such as an intelligent mobile phone or a tablet computer and is able to open a webpage.

The server may determine the name of the client terminal, for example, Sohu video application and UC browser, etc., according to the identification information.

According to some embodiments of this disclosure, the first acquisition module may include a first receiving submodule, which is configured for receiving the identification information, extracted by the webpage, of the client terminal that runs the webpage. Specifically, a code program for acquiring identification information of a client terminal is embedded into the running webpage, such that the code program may run to acquire identification information of the client terminal that runs the webpage before the client terminal opens the webpage; thereafter, the webpage will send the acquired identification information of the client terminal to the server.

According to other embodiments of this disclosure, the first acquisition module may include a second receiving submodule, which is configured for receiving the identification information of the client terminal that is sent by the client terminal. Specifically, the server may passively receive identification information sent by the client terminal; for example, the identification information may be carried in a webpage access request sent by the client terminal; after the server receives the webpage access request, it may extract the identification information of the client terminal from the webpage access request.

The second acquisition module 120 is configured for acquiring a page layout template of the client terminal corresponded to the identification information.

The server acquires page layout structures of various client terminals in advance, and generates corresponding page layout templates. After the client terminal that sends the webpage access request has been determined according to the identification information, a page layout template corresponded to the client terminal may be acquired from the page layout templates generated in advance.

The page generation module 130 is configured for laying out the webpage content requested by the webpage access request according to the page layout template, and obtaining a webpage to be accessed.

For example, if page blocks of a client terminal are set laterally in a single row, a page layout template with a single lateral row will be generated; if page blocks of the webpage requested to be accessed by the client terminal are set laterally in multiple rows, the blocks of the webpage requested to be accessed by the client terminal will be adjusted as one single lateral row according to the single lateral row layout of the client terminal.

The sending module 140 is configured for sending the webpage to be accessed to the client terminal.

The server sends the webpage to be accessed, which is generated according to the webpage layout template, to the client terminal, such that it may displayed by the client terminal.

In the apparatus for displaying a webpage according to this embodiment, the page layout pattern of the webpage to be accessed may be adjusted according to the page layout pattern of the client terminal that opens said webpage, that is, no matter what kind of client terminal is used to open the webpage, the page layout pattern of the webpage may be adjusted according to the page layout pattern of the client terminal, so that page layout pattern of a page of other websites displayed by the client terminal may be consistent with the page layout pattern of the client terminal itself. Thus, the user may have a consistent visual feeling and an improved user experience.

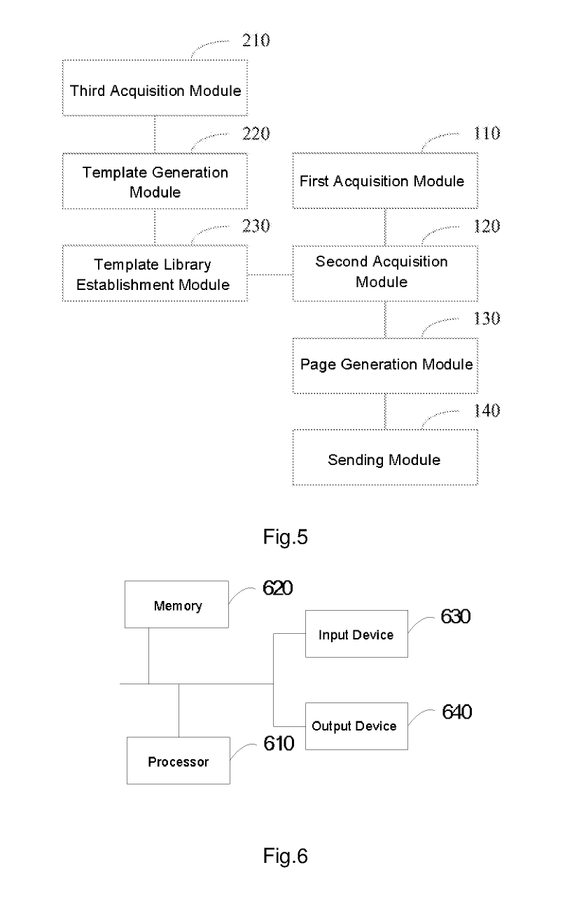

Referring to FIG. 5, it shows a block diagram of another apparatus for displaying a webpage according to one embodiment of the disclosure. On the basis of the embodiment shown in FIG. 4, the apparatus further includes a third acquisition module 210, a template generation module 220 and a template library establishment module 230.

The third acquisition module 210 is configured for acquiring page layout structures of each client terminal, wherein the page layout structures include page element collocation fashion and color information.

In some embodiments of the disclosure, page layout structure for each dominant client terminal may be analyzed by a webpage developer, that is, page layout pattern (for example, collocation fashion and color information, etc., of webpage elements) for each client terminal may be acquired by a webpage developer.

In other embodiments of this application, the third acquisition module is configured for extracting a page of the client terminal, and further analyzing the layout structure of the page.

The template generation module 220 is configured for generating page layout templates matching with page layouts of each client terminal according to the page layout structures.

The template library establishment module 230 is configured for establishing a mapping relation between the identification information of each client terminal and the page layout templates, and obtaining a page template library.

After the page template library is generated, the second acquisition module 120 may search for, according to the identification information of the client terminal obtained by the first acquisition module, the page layout template that matches with the identification information in the page template library established by the template library establishment module 230.

It should be noted that, the process of generating page layout templates in advance needs to be performed only once, and page layout templates thus generated may be directly used afterwards.

According to the apparatus for displaying a webpage according to this embodiment, the page layout pattern of a webpage to be accessed may be adjusted according to the page layout pattern of the client terminal that opens the webpage, that is, no matter what kind of client terminal is used to open the webpage, the page layout pattern of the webpage may be adjusted according to the page layout pattern of the client terminal, so that page layout pattern of a page of other websites displayed by the client terminal may be consistent with the page layout pattern of the client terminal itself. Thus, the user may have a consistent visual feeling and an improved user experience. Moreover, once page layout templates have been generated, they may be used directly afterwards, so as to improve webpage generation speed.

The present disclosure provides a non-volatile computer storage medium for storing computer executable commands, wherein the computer executable commands may execute any one of the above methods for displaying a webpage according to the embodiments of present disclosure.

FIG. 6 is a diagram illustrating a hardware structure of a server which may execute the method for displaying a webpage according to one embodiment of the disclosure. As shown in FIG. 6, the server includes:

at least one processor 610 and a memory 620, wherein only one processor 610 is illustratively shown in FIG. 6.

The server executing the method for displaying a webpage may also include: an input device 630 and an output device 640.

The processor 610, memory 620, input device 630 and output device 640 may be connected via a bus or other means, wherein a connecting bus is illustratively shown in FIG. 6.

The memory 620, as a non-volatile computer readable storage medium, may be used to store non-volatile software programs, non-volatile computer executable programs and modules, such as the program commands/modules corresponded to the method for displaying a webpage according to the embodiments in the present disclosure (for example, the first acquisition module 110, second acquisition module 120, page generation module 130 and sending module 140 illustrated in FIG. 4). The processor 610, by running non-volatile software programs, commands and modules stored in the memory 620, performs various functional applications and data processing of the server, i.e., carries out the method for displaying a webpage according to the above embodiments in the present disclosure.

The memory 620 may include a program storage area and a data storage area, wherein the program storage area may be used to store application programs needed by an operating system or by at least one function, and the data storage area may be used to store data created by running the apparatus for displaying a webpage, and the like. Moreover, the memory 620 may include a high speed random access memory, and also may include a non-volatile memory, such as at least one disk memory, flash memory, or other non-volatile solid state memory. According to some embodiments, the memory 620 may optionally include memories that are remotely setup with respect to the processor 610, and these remote memories may be connected to the apparatus for displaying a webpage via a network connection. An example of such a network includes, but not limited to, internet, intranet, local area network, mobile communication network, and a combination thereof.

The input device 630 may receive input digital or character information, and generate key signal inputs concerned with user setting and functional control of the apparatus for displaying a webpage. The output device 640 may include displaying means such as a display screen.

The at least one module is stored in the memory 620, and, when run by the at least one processor 610, executes the method for displaying a webpage according to any one of the above method embodiments.

The above product may excite the method provided by the embodiments of the present disclosure, and has functional modules and beneficial effects corresponded to the executed method. As for technical details that are not elaborated in the present embodiments, reference may be made to the method provided by the embodiments of the present disclosure.

The electronic devices in the embodiments of the present disclosure exists in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which may display and play multimedia contents, anc includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the apparatus are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it may be clearly understood by ordinary skill in the art that various embodiments may be realized by means of software in combination with necessary universal hardware platform, and certainly, may further be realized by means of hardware. Based on such understanding, the above technical solutions in substance or the part thereof that makes a contribution to the prior art may be embodied in a form of a software product which may be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications may be made to the technical solutions of the above embodiments, or part of technical features may be substituted with equivalents thereof. Such modifications and substitutions do not cause the corresponding technical features to depart in substance from the spirit and scope of the technical solutions of various embodiments of the present disclosure.

What is claimed is:

1. A method for displaying a webpage, comprising:
at a server;
receiving a webpage access request sent by a client terminal, and acquiring identification information of the client terminal;
acquiring a page layout template of the client terminal corresponded to the identification information;
laying out contents of the webpage requested by the webpage access request according to the page layout template, and obtaining a webpage to be accessed; and
sending the webpage to be accessed to the client terminal.

2. The method according to claim 1, further comprising:
acquiring a page layout structure of each client terminal, wherein the page layout structure comprises page element collocation fashion and color information;
generating a page layout template matching with the page layout of each client terminal according to the page layout structure; and
establishing a mapping relation between the identification information of each client terminal and page layout templates, and obtaining a page template library.

3. The method according to claim 2, wherein the step of acquiring a page layout template of the client terminal corresponded to the identification information comprises:
searching for a page layout template that matches with the identification information in the page template library according to the identification information.

4. The method according to claim 2, wherein the step of acquiring a page layout structure of each client terminal comprises:
acquiring a page of the client terminal, and obtaining the page layout structure of the client terminal by analyzing the page.

5. The method according to claim 1, wherein the step of acquiring identification information of the client terminal comprises:
receiving the identification information of the client terminal extracted from the webpage;
or,
receiving the identification information of the client terminal sent by the client terminal.

6. A non-volatile computer storage medium for storing computer executable commands, the computer executable commands are configured to:
receive a webpage access request sent by a client terminal, and acquire identification information of the client terminal;
acquire a page layout template of the client terminal corresponded to the identification information;
lay out contents of the webpage requested by the webpage access request according to the page layout template, so as to obtain a webpage to be accessed; and
send the webpage to be accessed to the client terminal.

7. The non-volatile computer storage medium according to claim 6, wherein the computer executable commands are further configured to:
acquire page layout structure of each client terminal, wherein the page layout structure comprises page element collocation fashion and color information;
generate a page layout template that matches with a page layout of each client terminal according to the page layout structure; and
establish a mapping relation between the identification information of each client terminal and the page layout templates, and obtain a page template library.

8. The non-volatile computer storage medium according to claim 7, wherein the step to acquire a page layout template of the client terminal corresponded to the identification information comprises:
searching for a page layout template corresponded to the identification information of the client terminal in the page template library.

9. The non-volatile computer storage medium according to claim 7, wherein the step to acquire page layout structure of each client terminal comprises:
acquiring a page of the client terminal, and obtaining the page layout structure of the client terminal by analyzing the page.

10. The non-volatile computer storage medium according to claim 6, wherein the step to acquire identification information of the client terminal comprises:
receiving the identification information of the client terminal that is extracted from the webpage;
or,
receiving the identification information of the client terminal sent by the client terminal.

11. A server, comprising:
at least one processor; and
a memory communicably connected with the at least one processor for storing instructions executable by the at least one processor, wherein execution of the instructions by the at least one processor causes the at least one processor to
receive a webpage access request sent by a client terminal, and acquire identification information of the client terminal;
acquire a page layout template of the client terminal corresponded to the identification information;
lay out contents of the webpage requested by the webpage access request according to the page layout template, so as to obtain a webpage to be accessed; and
send the webpage to be accessed to the client terminal.

12. The server according to claim 11, wherein the at least one processor are further caused to:
acquire page layout structure of each client terminal, wherein the page layout structure comprises page element collocation fashion and color information;
generate a page layout template that matches with a page layout of each client terminal according to the page layout structure; and
establish a mapping relation between the identification information of each client terminal and the page layout templates, and obtain a page template library.

13. The server according to claim 12, wherein the step to acquire a page layout template of the client terminal corresponded to the identification information comprises:
searching for a page layout template corresponded to the identification information of the client terminal in the page template library.

14. The server according to claim 12, wherein the step to acquire page layout structure of each client terminal comprises:
acquiring a page of the client terminal, and obtaining the page layout structure of the client terminal by analyzing the page.

15. The server according to claim 11, wherein the step to acquire identification information of the client terminal comprises:
receiving the identification information of the client terminal that is extracted from the webpage;
or,
receiving the identification information of the client terminal sent by the client terminal.
